(19) United States
(12) Patent Application Publication
(10) Pub. No.: US 2009/0142613 A1
(43) Pub. Date: Jun. 4, 2009

(54) Wood hardening procedures

(76) Inventor: Phillip Edward Cox, Tauranga (NZ)

Correspondence Address: JACOBSON HOLMAN PLLC, 400 SEVENTH STREET N.W., SUITE 600, WASHINGTON, DC, 20004, US

(21) Appl. No.: 11/920,246

(22) PCT Filed: May 10, 2006
(86) PCT No.: PCT/NZ2006/000105

§ 371 Date: Feb. 4, 2009

(30) Foreign Application Priority Data
May 11, 2005 (NZ) 539988

(51) Int. Cl. B32B 21/08; B05D 3/00

(52) U.S. Cl. 428/537.1; 427/297

(57) ABSTRACT

A process for providing a hardened wooden product from a source wooden item, said process comprising or including loading a pressure vessel with sapwood items of sufficient dryness, drawing a reduced pressure in the closed pressure vessel, immersing the sapwood in the pressure vessel in an aqueous aminoplast resin impregnating composition (‘aqueous formulation’), pressurising the impregnating composition in the treatment vessel, removing excess impregnating composition from the fully impregnated sapwood in the pressure vessel, lowering the pressure in the vessel, opening the pressure vessel, removing the impregnated sapwood from the pressure vessel, subjecting the removed impregnated sapwood to conditions to reduce its moisture content, subjecting the dryer impregnated sapwood to conditions to facilitate curing, subjecting the at least substantially cured impregnated sapwood to conditions to further reduce the moisture content thereof thereby to derive the hardened sapwood product.

### TECHNICAL FIELD

The present invention relates to wood hardening procedures.

### BACKGROUND ART

New Zealand Patent Specification 235036 discloses the so-called INDURITE™ process for the hardening of lumber, timber, wood or the like (hereafter “lumber products”) reliant upon an impregnation of the lumber products with a specific maltodextrin material capable of being cross-linked or cured within the lumber products thereby to form a composite material.

Such a procedure is disclosed in the aforementioned patent specification (the full content of which is here included by way of reference) as an alternative to then known polymeric impregnation systems. A variety of prior art procedures for making composite materials are disclosed in the aforementioned specification.

The present invention recognises that the INDURITE™ procedure at least at the commercial scale is limited as to the density to which a lumber product such as a conifer wood product can be successfully impregnated. Using the usual commercial 30-32 W/V solids water borne maltodextrin and MUF reagent it has traditionally been possible to take a conifer wood such as pinus radiata (average density about 425 kg/m³ and a hardness of about 4 on the Janka Scale) up in density in the range about 150-180 kg/m³ (e.g. to a density of about 620 kg/m³) and a hardness of about 5.2 on the Janka Scale.

Such a process has a formaldehyde emissions as desiccated tested of about 4.2 milligrams/litre of formaldehyde emissions.

New Zealand Patent No. 299261 (Hern) discloses an impregnation process using a high pH environment for an impregnation mixture of formaldehyde and urea. His pH control is, as the alkali addition, the presence of ammonia in a pressursed free gaseous form.

His process seemingly requires such high alkalinity as is available from the free ammonia presence for the retardation of the condensation type polymerisation. His mixing at usage of the formaldehyde (i.e. formalin) and the urea and not a urea taking of a product not requiring mixing prior to use other than in to more water.

The present invention by being a process reliant on a water bourne aminoplast resin system is directed to an alternative to the INDURITE™ procedures but which is one nevertheless has in prospect an ability to meet, by way of example, the Japanese agricultural standard of a maximum of 0.3 milligrams/litre of formaldehyde emissions. Indeed in preferred forms of the present invention free from formaldehyde emissions on the desiccated test basis have been as low as about 0.01 milligrams/litre. It is also an alternative process to that of New Zealand Patent No. 299261 which requires the use of ammonia gas.

The present invention, at least in its preferred embodiments, also or instead has in prospect the ability to give rise to a density increase to a maximum of about 1100 kg/m³ for a conifer species such as radiata pine having a pre-cursor density of about 400 to 500 kg/m³, (i.e. the process of the present invention has in prospect increases of density by up to from 650 to 700 kg/m³). At the same time preferred embodiments of the present invention have the prospect of increasing the hardness of the precursor radiata pine from 4 on the Janka Scale to from 12 to 13 on the Janka Scale.

Such density increases and hardness increases lead to better machinability and a wider range of applications. Moreover with the present invention not being dependent on starch and/or maltodextrin derived products, the resultant products of the present invention have the prospect of being used in circumstances where they may be subject to fungal and/or insect attack.

It is therefore to such systems procedures, products and products of the system or procedures that the present invention is directed as an alternative to at least the INDURITE™ process.

### DISCLOSURE OF INVENTION

The present invention includes a process for providing a hardened wooden product from a source wooden item, said process comprising or including

loading a pressure vessel with sapwood items of sufficient dryness,

drawing a reduced pressure in the closed pressure vessel,

immersing the sapwood in the pressure vessel in an aqueous aminoplast resin impregnating composition (“aqueous formulation”),

pressurising the impregnating composition in the treatment vessel,

removing excess impregnating composition from the fully impregnated sapwood in the pressure vessel,

lowering the pressure in the vessel,

opening the pressure vessel,

removing the impregnated sapwood from the pressure vessel,

subjecting the removed impregnated sapwood to conditions to reduce its moisture content,

subjecting the dryer impregnated sapwood to conditions to facilitate curing,

subjecting the at least substantially cured impregnated sapwood to conditions to further reduce the moisture content thereof thereby to derive the hardened sapwood product.

Treatable species for the process of the present invention include:
Albizzia
Balsa
Iroko (chlorophora excelsa)
Jelutong (dyera costulata)
Merbau (intsia palembacia)
Tawa (beilschmiedia tawa)
Radiata Pine (pinus radiata)
European Beech (gagus syivatica)
Eucalyptus (eucalyptus deglupta)
Cotton Wood (populus deltoids)
Aspen (populus tremuloides)
Rubber Wood (hevea brasiliensis)
Birch (betula alleghaniensis)
Baltic Pine (pinus sylvestris)
Ponderosa Pine (pinus ponderosa)
Hoop Pine (araucaria cunninghamii)
Carribbean Pine (pinus caribaca)
Loblolly Pine (pinus taeda)
Hemlock (tsuga canadensis)
Western Juniper (juniperus occidentalis)
Poplar (iriodendron tulipifera)
Willow (salix nigra)
Slash Pine (pinus elliottii)
White Pine (pinus strobes)
Poplar Hybrid (populus dehoidesXnigra)
Corsican Pine (pinus nigra subsp.laricio)

Other species can also have their sapwood treated and may also be appropriate. For example, cedars can be treated but their small sapwood content tends to be a deterrent to such a species being used widely in such impregnation processes.

Preferably the immersion and pressurisation steps are conducted in an environment at least substantially free of ammonia gas (i.e. is a free ammonia free impregnation).

The formulation is one having an in tank life preferably of at least two weeks (preferably up to at least 5 weeks).

Preferably the formulation is alkaline with a pH no greater than 9.

Preferably the formulation is at a pH of from 7 to 9 (most preferably 7.5 to 9).

Preferably the loading of the pressure vessel is with sapwood items of viable size, cross-section and length and of sufficient dryness. This usually involves kiln dried softwood and the selection therefrom of suitable sapwood pieces.

Alternatively sapwood pieces can be selected and thereafter dried to an appropriate dryness.

A preferred dryness of the sapwood to be loaded into the pressure vessel is from 10 to 25 w/w when expressed as water with respect to the original total weight of the sapwood prior to loss of water.

Preferably said lowering of the pressure is to a pressure in the range of from −20 to −85 KPa (most preferably about −85 KPa) preferably for a period of time of from 10 to 20 minutes.

To assist the efficiency of the process preferably the loading of the vessel has been such as to minimise void space.

Preferably the aqueous aminoplast impregnating resin is such as to provide a synthetic polymer.

The group of polymers suitable include aminoplast synthetic polymers, where a dialdehyde, aldehyde, and an amine or carbamide or combinations thereof, react (preferably, at least in part in-situ) in a condensation reaction at a temperature in a range of from 40° C. to 100° C. (preferably 60° C.-100° C.).

Optionally the dialdehyde is a glyoxal or glutaraldehyde or a aliphatic aldehyde, such as formaldehyde.

Optionally the amines can be melamine, triethylamine or similar.

The aminoplast is preferably fully cross-linked at least in part through reaction at an elevated temperature.

These resins have the following typical properties when used as the aqueous formulation:

| Viscosity | 10-60 mPa's |
|---|---|
| Solids content | 25-70% w/w |
| pH | 7.0-9.0 |

The degree of dilution desired, if any, immediately prior to use depends on the end densities wanted in the wood. The formulation as a premix may be at a solids content of from 60 to 70% w/w.

Preferably the formulation is a (proprietary) premixed urea formaldehyde aqueous system stabilised at a pH in the range 7 to 9 (more preferably 7.5 to 9), is a free ammonia free formulation and is a formulation that requires a temperature of 40° C. or greater to provide any rapidity of polymerisation.

Examples include Hexion BD829™, BASF Kauramin CE5549™, Dynea 323™, Valmel 303™ and Sylvic S402™.

Optionally the resin as supplied, optionally with further dilution, may have colourants or other elements added to it before or at least substantially simultaneously with impregnation.

Preferably the dye(s) used are chemically compatible and can cope with the pH range.

Preferably the loading of the aqueous aminoplast impregnating resin has been to a level actually or analogous to substantial refusal to take more into the wood at the pressurisation stage.

Preferably the refusal to accept more can be determined by reference to lack of further inflow or a slowing of inflow when at the threshold pressure or in the threshold range of pressures.

Preferably the determination of the full impregnation of the sapwood in the pressure vessel results from pumping in of the aqueous formulation to a threshold pressure, or to a threshold pressure range, for an appropriate period of time whereupon, by assessment or otherwise, full impregnation has been achieved (e.g. the impregnation has been to a stage of refusal to accept more of the impregnating composition at that pressure).

In Radiata, as an example, a preferred target is, may or can be a density of 650 kg/m3 of a Radiata Pine board originally of, say, a density of about 450 kg/m3

There are many ways of achieving this. For instance a formulation of 1.073 sg can be delivered into the wood at 740 l/m3, a formulation of 1.133 sg can be delivered into the wood at 550 l/m3, or a formulation of 1.267 sg can be delivered into the wood at 300 l/m3.

Operational factors may favour a formulation that allows reproducibility e.g. loading at a set pressure to refusal.

Times at elevated pressure are dependent on at least several factors as demonstrated by example later.

Preferably a suitable threshold pressure or pressure range for the pressurisation of the aqueous formulation is in the range of from about 150 to 1400 KPa (most preferably about 1000 to about 1400 KPa).

Preferably the removing of the excess aqueous formulation involves pumping from the vessel of at least some of the excess impregnating composition.

Preferably the lowering of the pressure in the vessel post impregnation is a drawing of a small vacuum (of about −20 to about −85 KPa) (most preferably about −50 KPa) for a sufficient period of time to allow some aqueous formulation that would otherwise be available at the surface of the sapwood to leave the sapwood or be easily removable from the sapwood.

Preferably the impregnated sapwood from the pressure vessel is subjected to a conventional kiln for drying purposes being operated in an unconventional cycle.

Preferably said unconventional cycle involves subjecting the impregnated sapwood from the pressure vessel to drying conditions, dependent on the thickness of the sapwood, of 50/40° to 90/80° C. for about 45 to about 65 hours to take the impregnated sapwood to a condition (e.g. 25-35% emc) where curing commences and/or speeds at an accelerated rate, and, preferably without any increase in the drying conditions, allowing the pH initiated polymerisation (“cure”) to occur to at least a substantial or to its full extent, and thereafter maintaining no more severe conditions post cure to achieve the further reduction of the moisture content.

Preferably the product resulting from the process has been impregnated with an aqueous aminoplast resin impregnating composition with a solids content in the range up to about 65% solids.

Preferably the range of solids beyond those previously discussed in respect of the INDURITE process is beyond 35% w/v.

In a further aspect the present invention consists in a process for providing a hardened wooden product from a source wooden item, said process comprising or including

loading a pressure vessel with conifer sapwood items of sufficient dryness,

drawing a reduced pressure in the closed pressure vessel,

immersing the sapwood in the pressure vessel in an aqueous aminoplast resin impregnating composition,

pressurising the impregnating composition in the treatment vessel by pumping in of further impregnating composition (“aqueous formulation”),

assessing by reference to impregnating composition inflow, if any, full impregnation,

removing excess impregnating composition from the fully impregnated sapwood in the pressure vessel,

lowering the pressure in the vessel to release some of the impregnating composition from the sapwood,

opening the pressure vessel,

removing the impregnated sapwood from the pressure vessel,

subjecting the removed impregnated sapwood to conditions to reduce its moisture content, achieve cure, and to further reduce moisture,

thereby to derive the hardened sapwood product.

Preferably the immersion and pressurisation steps are conducted in an environment at least substantially free of ammonia gas (i.e. is a free ammonia free impregnation).

The formulation is one having an in-tank life preferably of at least two weeks (preferably up to at least 5 weeks).

Preferably the formulation is alkaline with a pH no greater than 9.

Preferably the formulation is at a pH of from 7 to 9 (most preferably 7.5 to 9).

In yet a further aspect the present invention consists in a process substantially as herein described with reference to FIG. 1 or 2, or both, of the accompanying drawings and/or using any of the parameters of operation for any of the stages herein described and/or as shown in FIG. 1 or 2, or both, of the accompanying drawings.

In still a further aspect the present invention consists in a hardened sapwood product where the hardness is above 6 on the Janka Scale and/or preferably where it has a density above 700 kg/m³.

Most preferably the hardness and/or density is substantially as herein described.

Preferably the process has involved an emission of free formaldehyde, if any emission, below the allowed level referred to previously.

The invention in another aspect consists in lumber products (preferably of a conifer species) having a free formaldehyde emission level below 0.3 milligrams/litre, a hardness above 6 on the Janka Scale and/or a density above 700 kg/m³.

Preferably the hardness is in the range of from 620 kg/m³ to about 1100 kg/m³ and preferably is above 700 kg/m³.

Preferably the hardness is above 8 on the Janka Scale and preferably above 9 on that scale. In some forms of the present invention, the hardness is in the range of from 9 to about 13 on the Janka Scale.

In some forms of the present invention the emission of free formaldehyde is below 0.1 milligrams/litre.

Preferably the product has had a aminoplast resin system (preferably water borne) as its impregnant cured therein.

### BRIEF DESCRIPTION OF DRAWINGS

Forms of the present invention will now be described by way of example with reference to the accompanying drawings in which

FIG. 1 shows a preferred procedure,

FIG. 2 shows a simplified procedure, and

FIGS. 3A and 3B show for the untreated and treated Radiata Pine blocks respectively Example 1 fire test data (Heat Release in kw/m² versus time.

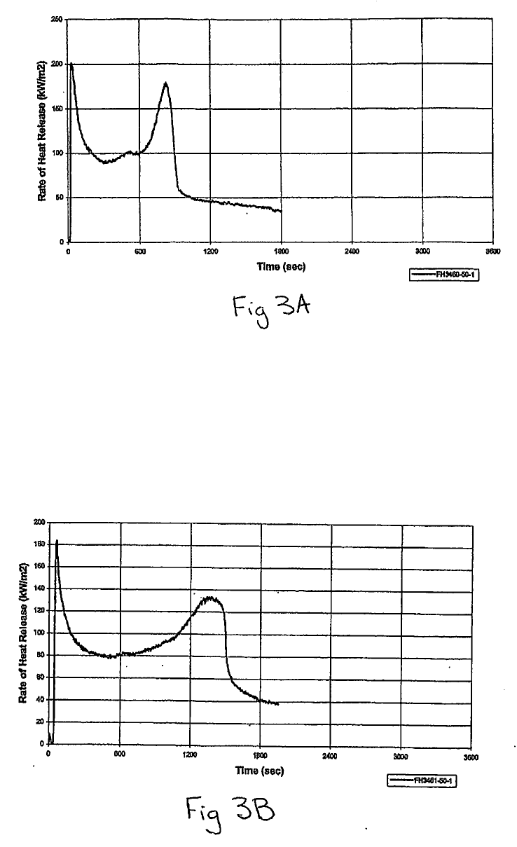

Whilst a preferred method described herein is by reference to Radiata Pine, other species as non-exhaustively listed can also be targeted.

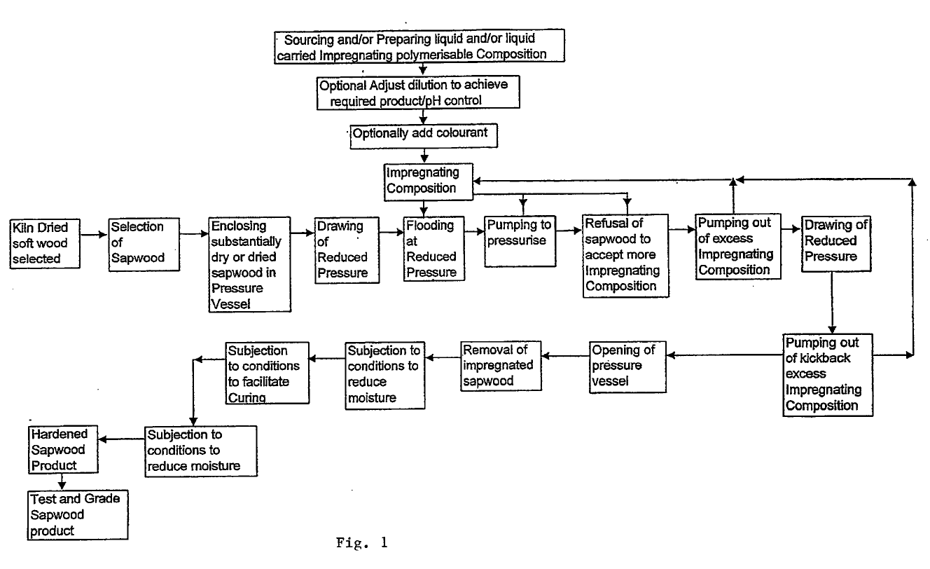

A preferred procedure is that shown in FIG. 1 where each stage preferably is performed with parameters as aforesaid.

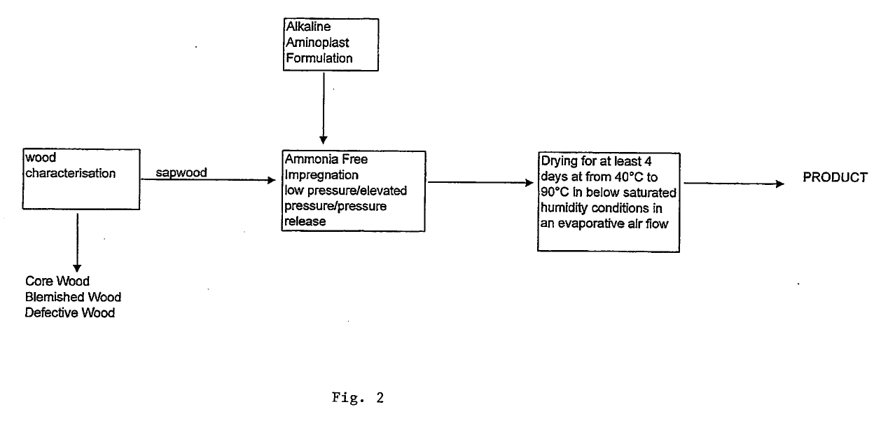

A preferred form of the present invention in a more simplified form but with more details is described by reference to FIG. 2. Here a wood type, (e.g. radiata pine) is subjected to appropriate milling and the wood characterisation step rejects core wood and any blemished or defective wood (i.e. with inappropriate knots or other defects, inappropriate lengths and/or cross sections, unwanted warping, unwanted sweep etc.).

It is preferred that the cross-sections of the timber to be treated by the process is as close to final size as possible so as to avoid wastage of formulation and wastage of formulation in wood dust. Ideally the cross-section should be in each of its major axes (square or rectangular) within say 2-3 mm of the final size.

Whilst it is always possible to attempt to treat material to the final size the post treatment can vary and there is therefore some merit in ensuring an appropriate surface finish for any part of a treated piece of timber that is to be viewable.

The sap wood preferably at a desired dryness, (i.e. preferably from 10 to 25 w/w when expressed as water with respect to the original total weight of the sap wood prior to the loss of water), is then closely packed into a preferably shaped cavity pressure vessel to minimise formulation volume need for a fill.

It is then subjected to a pressure of from −20 to −85 KPa (most preferably about −85 KP for a period of time from 10 to 20 minutes.

The vessel is then loaded with the formulation of the aqueous aminoplast impregnating resin at a pH in the range of from 7 to 9 (more preferably 7.5 to 9).

A preferred resin composition is Orica New Zealand Limited sourced Sylvic S402™. Alternatives however exist and these include Hexion BD829™, BASF Kauramin CE5549™, Dynea 323™ and Valmel 303™.

A desired solids content of the aqueous resin formulation is from 25-70% w/w with a viscosity of 10 to 60 mPa. It may be diluted down to a solids content of 25% w/w from a higher as supplied solids content at the time of tank filling.

The pressure vessel is then pressurised at a pressure in the range of 150 to 1400 KPa (most preferably about 1000 to about 1400 KPa). That pressurisation step is preferably held for a period of time sufficient to provide little further inflow or a slowing of inflow into the wood that is commensurate with refusal. This vary in time depending on the size of the wood pieces in the pressure vessel. Also ¼ sawn timber requires more time under pressure.

By way of example a 150×25 mm board of Radiata Pine sapwood that has not been ¼ sawn, when being pressurised at 1400 kPa with a 1.093 sg formulation and to a target density of 650 kg, may take from 15 to 20 minutes.

By way of example a 150×40 mm board of Radiata Pine sapwood that has not been ¼ sawn, when being pressurised at 1400 kPa with a 1.093 sg formulation and to a target density of 650 kg, may take from 25 to 90 minutes.

By way of example a 100×50 mm board in ±14 sawn timber of Radiata Pine sapwood, when being pressurised at 1400 kPa with a 1.093 sg formulation and to a target density of 650 kg, may tale from 25 to 60 minutes.

There is then preferably a release of the pressure at least to ambient atmosphere and preferably a drawing of the small vacuum. Preferably that drawing of a small vacuum is of about −20 to about −85 KPa (most preferably about −50 KPa) for sufficient period of time to allow some impregnating composition that would otherwise be available at the surface of the sap wood to leave the sap wood or be more easily removable from the sap wood.

There then follows drying of the impregnated wood following removal and the keeping of the same from being wet (e.g. by rain) post treatment. Drying preferably takes a period of at least 4 days (typically 4 to 15 days). Preferably such drying is in a kiln where preferably drying is effected at from 40° C. to 90° C. in below saturated humidity conditions in an evaporative air flow. This elevated temperature (elevated above ambient temperature(s)) and removal of moisture (by evaporative air flow of appropriate humidity) has the effect of expediting what would otherwise be preferably an inevitable but very slow polymerisation of the formulation owing to the slight alkaline conditions employed and of course the interference on that pH insofar as the in wood formulation is concerned from the pH of the wood itself.

The resultant product has the characteristics referred to previously and hereinafter described.

In Radiata, as an example, a preferred target is or can be a density of 650 kg/m3 of the Radiata Pine board originally of a density of about 450 kg/m3

There are many ways of achieving this. For instance a formulation of 1.073 sg (specific gravity) can be delivered into the wood at 740 l/m3, and a formulation of 1.133 sg can be delivered into the wood at 550 l/m3, and a formulation of 1.267 sg can be delivered into the wood at 300 l/m3.

Operational factors may favour a formulation that allows reproducibility e.g. loading of a set pressure to refusal.

Table 1 shows a relationship for Radiata Pine of sg/density/Janka hardness.

TABLE 1
Treated Radiata Pine

| | Density Kg/M3 | Janka hardness kn |
|---|---|---|
| Specific gravity | Average | Average |
| 1.073 | 625 | 5.7 |
| 1.093 | 670 | 7.1 |
| 1.133 | 780 | 7.9 |
| 1.267 | 995 | 12.3 |

The following two examples of a Fire Test are of Radiata Pine treated with 1.093 sg aqueous Sylvic S402™ formulation to about 7.4 kn janka.

### EXAMPLE 1

### Fire Test

AS/NZS 3837

CONTROL - UNTREATED

| Specimen Thickness | 22.0 | mm | (g) |
|---|---|---|---|
| Specimen Initial Mass | 95.4 | g | (h) |
| Exposed Sample Area | 0.0088 | m2 | |
| Overall Apparent Density | 433.2 | kg/m3 | |
| Nominal Heat Flux | 50.0 | kW/m2 | (l) |
| Nominal Duct Flow Rate | 0.024 | m3/sec | (l) |
| Orientation | H | | |
| Time to sustained flaming | 15.0 | sec | (n) |
| Test Duration | 96.0 | sec | (o) |
| Specimen Final Mass | 17.2 | g | (u) |
| Percentage of Total Mass | 81.9% | | (u) |
| Pyrolyzed | | | |

OVER THE ENTIRE TEST DURATION

| | | | |
|---|---|---|---|
| Peak Heat Release Rate | 201.2 | kW/m2 | (q) |
| Total Heat Release | 106.7 | MJ/m2 | (r) |
| Average Heat of Combustion | 12.1 | MJ/kg | (s) |
| Average Smoke Extinction Area | 56 | m2/kg | (w) |

FROM IGNITION TO TEST END

| | | | | | |
|---|---|---|---|---|---|
| Ignition plus | 60.0 | | 180 | 300 seconds | |
| Average heat release rate | 153.2 | | 130.6 | 116.1 kW/m2 | (q) |
| Sample Mass Loss (from Ignition) | 8.74 | kg/m2 | | | (v) |
| Average Mass Loss Rate (from | 9.2 | g/m2.s | | | (v) |
| ignition) | | | | | |
| Average HRR from ign | 112.9 | kW/m2 | | | |

TREATED

| Specimen Thickness | 22.1 | mm | (g) |
|---|---|---|---|
| Specimen Initial Mass | 164.6 | g | (h) |
| Exposed Sample Area | 0.0088 | m2 | |
| Overall Apparent Density | 744.8 | kg/m3 | |
| Nominal Heat Flux | 50.0 | kW/m2 | (l) |
| Nominal Duct Flow Rate | 0.024 | m3/sec | (l) |
| Orientation | H | | |
| Time to Sustained flaming | 40.0 | sec | (n) |
| Test Duration | 234.0 | sec | (o) |
| Specimen Final Mass | 139.9 | g | (u) |
| Percentage of Total Mass | 15.0% | | (u) |
| Pyrolyzed | | | |

OVER THE ENTIRE TEST DURATION

| | | | |
|---|---|---|---|
| Peak Heat Release Rate | 183.3 | kW/m2 | (q) |
| Total Heat Release | 22.9 | MJ/m2 | (r) |
| Average Heat of Combustion | 8.2 | MJ/kg | (s) |
| Average Smoke Extinction Area | 11 | m2/kg | (w) |

FROM IGNITION TO TEST END

| Ignition plus | 60.0 | | 180 | 300 seconds | |
|---|---|---|---|---|---|
| Average heat release rate | 139.1 | | 119.1 | 117.3 kW/m2 | (q) |
| Sample Mass Loss (from ignition) | 1.95 | kg/m2 | | | (v) |
| Average Mass Loss Rate (from | 10.0 | g/m2 · s | | | (v) |
| ignition) | | | | | |
| Wire grid | N | | | | |
| Retainer frame | Y | | | | |
| Average HRR from ign | 117.2 | kW/m2 | | | |

The first peak is that relating to ignition. After ignition the combustion process settles down to a relatively stable rate as it burns through the block. The second and final peak is essentially when the fire reaches the back face of the specimen—basically oxygen can get to both the exposed and unexposed surfaces and the last part can burn more readily. The initial peak heat release rates are not all that different and so may not make all that much difference in regard to flame spread performance.

The treated specimens demonstrate quite a dramatic improvement over the untreated in terms of charring rate, or the time for combustion to reach the unexposed face. It is possible that this feature could be put to good use in fire doors, door frames and items such as the glazing beads.

Another modified performance was in the time to ignition. This was delayed from 15 and 17 seconds to 34 and 40 seconds.

The appearance of post-treatment dressed timbers of any suitable species treated by any of the procedures of the present invention can be without additional colouration in addition to the bare treatment composition or can carry into the wood the affects of any die that is compatible and may be present. Such aesthetics and hardness of the finished wood lends itself to wide spread applications in building, joinery, flooring, etc.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

What we claim is:

1. A process for providing a hardened wooden product from a source wooden item, said process comprising or including
loading a pressure vessel with sapwood items of sufficient dryness,
drawing a reduced pressure in the closed pressure vessel,
immersing the sapwood in the pressure vessel in an aqueous aminoplast resin impregnating composition (“aqueous formulation”),
pressurising the impregnating composition in the treatment vessel,
removing excess impregnating composition from the fully impregnated sapwood in the pressure vessel,
lowering the pressure in the vessel,
opening the pressure vessel,
removing the impregnated sapwood from the pressure vessel,
subjecting the removed impregnated sapwood to conditions to reduce its moisture content,
subjecting the dryer impregnated sapwood to conditions to facilitate curing,
subjecting the at least substantially cured impregnated sapwood to conditions to further reduce the moisture content thereof thereby to derive the hardened sapwood product.

2. A process of claim 1 wherein the immersion and pressurisation steps are conducted in an environment at least substantially free of ammonia gas (i.e. is a free ammonia free impregnation).

3. A process of claim 1 or 2 wherein the aqueous formulation is one having an in tank life of at least two weeks.

4. A process of any one of the preceding claims wherein the formulation is alkaline with a pH no greater than 9.

5. A process of claim 4 wherein the aqueous formulation is at a pH of from 7 to 9.

6. A process of claim 5 wherein the pH is from 7.5 to 9.

7. A process of any one of the preceding claims wherein the sapwood is from the species:
Albizzia,
Balsa,
Iroko (chlorophora excelsa),
Jelutong (dyera costulata),
Merbau (intsia palembacia),
Tawa (beilschmiedia tawa),
Radiata Pine (pinus radiate),
European Beech (gagus syivatica),
Eucalyptus (eucalyptus deglupta),
Cotton Wood (populus deltoids),
Aspen (populus tremuloides),
Rubber Wood (hevea brasiliensis),
Birch (betula alleghaniensis),
Baltic Pine (pinus sylvestris),
Ponderosa Pine (pinus ponderosa),
Hoop Pine (araucaria cunninghamii),
Carribbean Pine (pinus caribaea),
Loblolly Pine (pinus taeda),
Hemlock (tsuga canadensis),
Western Juniper (juniperus occidentalis),
Poplar (liriodendron tulipifera),
Willow (salix nigra),
Slash Pine (pinus elliottii),
White Pine (pinus strobes),
Poplar Hybrid (populus dehoidesXnigra) or
Corsican Pine (pinus nigra subsp.laricio).

8. A process of any one of the preceding claims wherein the loading of the pressure vessel with sapwood items of sufficient dryness involves selected sapwood that has been kiln dried or kiln dried softwood from which suitable sapwood is selected.

9. A process of any one of the preceding claims wherein dryness of the sapwood to be loaded into the pressure vessel is from 10 to 25 w/w when expressed as water with respect to the original total weight of the sapwood prior to loss of water.

10. A process of any one of the preceding claims wherein said lowering of the pressure is to a pressure in the range of from −20 to −85 KPa for a period of time of from 10 to 20 minutes.

11. A process of any one of claim 10 wherein said lowering of the pressure is to about −85 KPa.

12. A process of any one of the preceding claims wherein the aqueous formulation is of a polymerising kind where a dialdehyde, aldehyde, and an amine or carbamide or combinations thereof, react in a condensation reaction.

13. A process of claim 12 wherein dialdehyde is a glyoxal or glutaraldehyde or a aliphatic aldehyde.

14. A process of claim 12 or 13 wherein amine(s) is melamine, triethylamine and/or similar.

15. A process of any one of the preceding claims wherein aminoplast is preferably fully cross-linked through reaction at an elevated temperature.

16. A process of any one of the preceding claims wherein the aqueous formulation at impregnation has the following properties:

| Viscosity | 10-60 mPa's |
|---|---|
| Solids content | 25-70% w/w |
| pH | 7.0-9.0 |

17. A process of claim 16 wherein the aqueous formulation prior to optional dilution has been supplied at a solids content of from 60 to 70% w/w.

18. A process of any one of the preceding claims wherein the aqueous formulation is a premixed urea formaldehyde aqueous system (optionally diluted further prior to use), is stabilised at a pH in the range 7 to 9, is a free ammonia free formulation and is a formulation that requires temperature(s) 40° C. (or greater) to provide any rapidity of polymerisation.

19. A process of claim 18 wherein temperature(s) 60° C. or greater are used.

20. A process of claim 18 or 19 wherein the pH is in the range of from 7.5 to 9.

21. A process of any one of the preceding claims wherein the aqueous formulation may have colourants or other elements added to it or its component(s) before or simultaneously with impregnation.

22. A process of any one of the preceding claims wherein loading of the aqueous formulation has been to a level actually or analogous to substantial refusal to take more into the wood at the pressurisation stage.

23. A process of claim 22 wherein refusal to accept more has been determined by reference to lack of further inflow or a slowing of inflow when at the threshold pressure or in the threshold range of pressures.

24. A process of any one of claims 1 to 23 wherein the determination of the full impregnation of the sapwood in the pressure vessel results from pumping in of the aqueous formulation to a threshold pressure, or to a threshold pressure range, for an appropriate period of time whereupon, by assessment or otherwise, full impregnation has been achieved (e.g. the impregnation has been to a stage of refusal to accept more of the impregnating composition at that pressure).

25. A process of any one of the preceding claims removing of the excess aqueous formulation involves pumping from the vessel of at least some of the excess aqueous formulation.

26. A process of claim 24 or 25 wherein a threshold pressure or pressure range for the pressurisation of the aqueous formulation is in the range of from about 150 to 1400 KPa.

27. A process of claim 26 wherein the pressurisation is in the range of from about 1000 to about 1400 KPa.

28. A process of any one of the preceding claims wherein the lowering of the pressure in the vessel post impregnation is a drawing of a small vacuum.

29. A process of claim 28 wherein said small vacuum is of about −20 to about −85 KPa for a sufficient period of time to allow some impregnating composition that would otherwise be available at the surface of the sapwood to leave the sapwood or be easily removable from the sapwood.

30. A process of claim 29 wherein said small vacuum is about −50 KPa.

31. A process of any one of the preceding claims wherein the impregnated sapwood from the pressure vessel is subjected to a drying kiln operated in an unconventional cycle.

32. A process of claim 31 wherein said unconventional cycle involves subjecting the impregnated sapwood from the pressure vessel to drying conditions, dependent on the thickness of the sapwood, of 50/400 to 90/80° C. for about 45 to about 65 hours to take the impregnated sapwood to a condition (e.g. 25-35% emc) where curing commences and/or speeds at an accelerated rate.

33. A process of claim 32 wherein, without any increase in the drying conditions, pH initiated polymerisation (“cure”) is allowed to occur to at least a substantial or to its full extent.

34. A process of claim 32 or 33 wherein there is a maintaining of no more severe conditions post cure to achieve the further reduction of the moisture content.

35. A process of claim 31 wherein the temperature range in the kiln post impregnation is from 40° C. to 100° C.

36. A process of any one of the preceding claims wherein the impregnated sapwood is subjected to a temperature in a range of above 60° C. post impregnation.

37. A process for providing a hardened wooden product from a source wooden item, said process comprising or including
loading a pressure vessel with conifer sapwood items of sufficient dryness,
drawing a reduced pressure in the closed pressure vessel,
immersing the sapwood in the pressure vessel in an aqueous aminoplast resin impregnating composition,
pressurising the impregnating composition in the treatment vessel by pumping in of further impregnating composition,
assessing by reference to impregnating composition inflow, if any, full impregnation,
removing excess impregnating composition from the fully impregnated sapwood in the pressure vessel,
lowering the pressure in the vessel to release some of the impregnating composition from the sapwood,
opening the pressure vessel,
removing the impregnated sapwood from the pressure vessel,
subjecting the removed impregnated sapwood to conditions to reduce its moisture content, achieve cure, and to further reduce moisture, thereby to derive the hardened sapwood product.

38. A process of claim 37 wherein the immersion and pressurisation steps are conducted in an environment at least substantially free of ammonia gas (i.e. is a free ammonia free impregnation).

39. A process of claim 37 or 38 wherein the formulation is alkaline with a pH no greater than 9.

40. A process of claim 39 wherein the formulation is at a pH of from 7 to 9.

41. A, process substantially as herein described with reference to FIG. 1 of the accompanying drawings and/or using any of the parameters of operation for any of the stages herein described and/or as shown in FIG. 1 of the accompanying drawings.

42. A hardened sapwood product hardened by an aqueous impregnating formulation subsequently polymerised where the hardness is above 6 on the Janka Scale or it has a density above 700 kg/m³.

43. A product of claim 42 that has involved an emission of free formaldehyde below 0.3 milligrams/litre Japanese Agricultural Standard.

44. A lumber product having a free formaldehyde emission level below 0.3 milligrams/litre, and having a hardness above 6 on the Janka Scale or a density above 700 kg/m³, or both.

45. A product of claim 44 having a density in the range of from 620 kg/m³ to about 1100 kg/m3

46. A product of claim 44 or 45 wherein the hardness is above 8 on the Janka Scale.

47. A product of claim 46 having a hardness above 9 on the Janka Scale.

48. A product of claim 44 or 45 wherein the hardness is in the range of from 9 to about 13 on the Janka Scale.

49. A product of any one of claim 44 to 48 where the emission of free formaldehyde is below 0.1 milligrams/litre.

50. A product of any one of claims 44 to 49 which has had a aminoplast resin system as its impregnant cured therein.

51. A product of claim 50 wherein it has been an aqueous system.
